(19) United States
(12) Patent Application Publication
(10) Pub. No.: US 2025/0066056 A1
(43) Pub. Date: Feb. 27, 2025

(54) PACKAGING UNIT FOR PACKAGING ARTICLES IN BOXES AND METHOD FOR PACKAGING ARTICLES IN BOXES

(71) Applicant: R.A JONES & CO., Covington, KY (US)

(72) Inventors: Andrea BIONDI, Bologna (IT); Luca CAVAZZA, Bologna (IT); Ivanoe BERTUZZI, Bologna (IT); Enrico CAMPAGNOLI, Bologna (IT); Antonio GIGANTE, Bologna (IT)

(21) Appl. No.: 18/725,069

(22) PCT Filed: Dec. 23, 2022
(86) PCT No.: PCT/IB2022/062715

§ 371 Date: Jun. 27, 2024

(30) Foreign Application Priority Data
Dec. 29, 2021 (IT) 102021000033008
Dec. 29, 2021 (IT) 102021000033011
Dec. 29, 2021 (IT) 102021000033017

(51) Int. Cl. B65B 43/28; B31B 50/32; B31B 100/00; B65B 41/02; B65B 59/00

(52) U.S. Cl. CPC B65B 43/285; B31B 50/32; B65B 41/02; B65B 59/001; B65B 59/003; B31B 2100/00

(57) ABSTRACT

A packaging unit for packaging (100; 200; 300) articles (1) in boxes (2), comprises: a mandrel (10) for accommodating an article (1) inside it; a movement device (50) for moving said mandrel (10) along a movement trajectory (M); a feed device (30) for feeding a blank (7) towards said mandrel (10) along a feeding trajectory which intersects the movement trajectory (M); a folding device (20) mounted at the movement trajectory (M) for cooperating with said mandrel (10) to fold said blank (7) around the mandrel (10) and to form a box (2). The folding device (20) comprises a folding element (21) for abutting said blank (7) positioned between said mandrel (10) and said folding element (21), and an adjustment device for modifying the position of the folding element (21) and for adjusting the folding of the blank (7) around the mandrel (10).

The present invention concerns a unit and a method for packaging articles in boxes, particularly suitable for packaging articles in accordance with a process in which it is provided to form the box around the article to be packaged, known in the art as “wrap-around” process.

The content of the following patent applications, filed on the same date by the same Applicant, is considered incorporated herein in their entirety:
Italian patent application No. 102021000032948 entitled “Packaging unit for packaging articles in boxes and method for packaging articles in boxes” filed on 29 Dec. 2021;
Italian patent application No. 102021000032993 entitled “Packaging unit for packaging articles in boxes and method for packaging articles in boxes” filed on 29 Dec. 2021;
Italian patent application No. 102021000032984 entitled “Packaging unit for packaging articles in boxes and method for packaging articles in boxes” filed on 29 Dec. 2021;
Italian patent application No. 102021000032915 entitled “Unit and method for packaging articles in boxes” filed on 29 Dec. 2021;
Italian patent application No. 102021000033011 entitled “Packaging unit for packaging articles in boxes and method for packaging articles in boxes” filed on 29 Dec. 2021;
Italian patent application No. 102021000033008 entitled “Packaging unit for packaging articles in boxes and method for packaging articles in boxes” filed on 29 Dec. 2021;
Italian patent application No. 102021000033017 entitled “Packaging unit for packaging articles in boxes and method for packaging articles in boxes” filed on 29 Dec. 2021.

The present invention finds a preferred, although not exclusive, application in the field of packaging in boxes articles with variable geometry and which are relatively delicate, such as for example bags of corn flakes, a sector to which reference may be made below without losing generality.

In particular, in the relevant technical field, it is known to package articles into a box according to some distinct manners.

A first manner provides a first step of forming a box, which is open at least at one end thereof, the subsequent insertion of the article to be packaged into the open box and, then, the closure of the open end.

In a second manner, the box is formed by wrapping a blank around a mandrel which is made of rigid material, for example of metal, and which contains the article to be packaged. This manner provides that the blank is wrapped around the mandrel so as to form a box that is closed laterally but open at one end thereof, from which the mandrel is then extracted leaving the article inside the newly formed box. Also in this case, the open end can be conveniently closed, so that the package thus made can be sent to the final steps of packaging and shipment to the points of sale. In this manner, a folding device is provided which folds the blank around the mandrel. The folding device may comprise a plurality of folding elements each intended to form a distinct face of the box.

In this description as well as in the accompanying claims, certain terms and expressions are deemed to have, unless otherwise expressly indicated, the meaning expressed in the following definitions.

The term “article” means any product that can be packaged in boxes. The articles can have a predetermined geometric shape or they can have a variable geometry. Preferably, the articles are food and confectionery articles, in bulk or contained inside bags or other types of wrapping, such as for example cereal bags or coffee capsules or other infusion beverages, single chocolates (wrapped or not), candies, pouches containing solid, liquid or semi-solid food products; in addition, articles of the ceramic industry, absorbent articles for hygienic use, articles of the tobacco industry, articles of the cosmetic industry, articles of the pharmaceutical industry, articles of the “personal & home care” industry.

By “packaging” one or more articles in a box, it is meant the fact of obtaining a box containing said one or more articles. Such packaging can be obtained by inserting one or more articles into an already formed box or, preferably, it can be obtained by forming a box around the one or more articles to be contained.

By “mandrel” it is meant a container capable, on the one hand, of accommodating and supporting the article to be packaged and, on the other hand, of providing an effective abutment for folding the blank when wrapped around it.

By “blank” it is meant a shaped sheet of appropriate material and thickness which is suitable to be wrapped by folding around a mandrel to form a box. Preferably, the blank is made of cardboard. Preferably, the blank has a thickness of at least 0.2 mm, more preferably less than 4 mm. In a greatly preferred manner, the blank has a thickness comprised between 0.25 mm and 1.6 mm, more preferably between 0.3 mm and 1 mm, even more preferably between 0.4 and 0.8 mm.

A “folding line” of a blank is a predefined line around which two blank panels are provided to rotate relative to each other so as to fold the blank, preferably around the mandrel. The folding line can be a virtual, albeit predefined line. The folding line is preferably defined by a line of weakness obtained on the blank, such as for example a crease, or an incision or a plurality of aligned holes.

In general terms, a first element “abuts” a second element when the first element touches the second element and is able to at least partially oppose a relative displacement of the first element against the second element.

In particular, the blank is “abutted” by a component of the packaging unit, such as for example a mandrel or a folding device, when the component, in order to fold the blank around the folding line, abuts the blank at a distance from the folding line which is less than 10 times the thickness of the blank, preferably less than 5 times the thickness of the blank. In some versions, the abutment provides for the contact between the blank and the component of the packaging unit.

In view of the thickness of the blanks that are used in the sector of packaging articles in boxes, a folding line may be considered to be “abutted” by a component of the packaging unit when the component, in order to fold the blank around the folding line, abuts the blank at a distance from the folding line which is less than 5 mm, preferably less than 3 mm.

It should be noted that the abutment of the blank does not imply in itself that the blank is abutted for its entire surface by a component of the packaging unit, such as for example the mandrel or the folding device, but it is sufficient for it to be abutted to an extent such as to allow the correct folding necessary for the formation of the box.

By “box” it is meant any container suitable for containing a plurality of articles for the purpose of their packaging, which can be made starting from a blank by folding around a mandrel and subsequent fixing at edges or panels thereof. Preferably, the box has at least one closed contour section, more preferably it is closed laterally around the mandrel while the longitudinal ends are kept open.

The term “trajectory” refers to the linear path travelled by an object, for example a mandrel or a blank, during its displacement. The trajectory is represented by an oriented line. A “stroke” or a “portion” of a trajectory are also represented by oriented lines.

When a trajectory, or a stroke thereof, are comprised within a plane, that plane is defined as the “advancement plane” of the object.

With reference to a particular trajectory, a first element has an “advanced position” or is positioned “downstream” with respect to a second element when along the oriented line identified by such trajectory, the first element is in a position that is subsequent to the position of the first element. In a completely similar way, a “backward position” and a position “upstream” of a first element with respect to a second element are also defined.

A vector quantity, for example the speed, is defined by a “modulus” and by a “direction”, herein intended to include also the sense of direction, and can be represented by an oriented segment of length equal to the “modulus” and oriented in the sense of direction indicated by the “direction”.

By the term portion of cylindrical surface it is meant a portion of side surface of a cylinder corresponding to a desired angle of rotation. Similarly, the term portion of conical surface means a portion of side surface of a cone corresponding to a desired angle of rotation.

A radial direction is a direction passing through the centre of rotation of a circumference.

The Applicant has preliminarily observed that the wrap-around type packaging process briefly illustrated above allows to obtain significant advantages in terms of flexibility compared to the packaging process with insertion of the article in the preformed box. In fact, in the wrap-around type packaging process, the times required to switch from one format to another or to bring new formats into production is significantly reduced.

However, the Applicant has observed that in this packaging process when the mandrel is brought to high speeds, for example to increase the production capacity of the apparatus, the blanks may be torn or ripped during wrapping around the mandrel, in particular when the blanks have limited thickness and impact resistance.

The Applicant has also observed that in the packaging process it is provided for applying a certain amount of glue on a flap of the blank before the folding step, so that two opposed flaps of the blank itself can be subsequently glued to form the open box.

The Applicant has in fact noted that in the wrap-around packaging process there are smears or splashes of glue and that some quantities of glue are deposited on the work surfaces, or on the machinery involved in the packaging process, or arranged near the packaging unit. The Applicant has verified that this negatively affects the productivity of the packaging process, because it involves a greater frequency of interventions for the maintenance and cleaning of machinery in order to remove glue residues.

In addition, the Applicant has verified that such smears may result in a decrease in the quality of the boxes produced both due to an albeit minimal decrease in the glue available on the blank for the boxes to be glued and also due to a displacement of the glue from the application area. This causes a decrease in the gluing accuracy and sealing of the box.

These drawbacks are more evident as the dimensions of the boxes to be formed and, therefore, of the blank to be folded on the mandrel increase.

In particular, the Applicant has observed that one of the critical steps in the process of packaging articles in boxes is constituted by the first folding of the blank on the mandrel through the folding device, i.e. the passage of the blank from the planar feeding configuration to a configuration folded on the mandrel.

The Applicant has in fact verified that at this step the aforementioned ripping of the blank and the aforementioned smears of glue can occur. The Applicant has also verified that the first folding of the blank substantially affects the wrapping of the blank on the mandrel and, therefore, the quality of the box obtained.

The Applicant has also observed that, especially when the packaging process is carried out at high speeds, for example to increase the production capacity of the apparatus, the blanks may not be correctly wrapped around the mandrel obtaining boxes with non-precise or regular shape. To obtain a correctly formed box, i.e. in which the blank is folded correctly along the folding lines and the flaps of the blank are correctly glued to close the box, it is necessary that the blank and the folding device are correctly positioned with respect to each other.

For this purpose, the Applicant has observed that the blank is fed via a suitable feed device to the packaging unit in a planar configuration. The blank is interposed between the mandrel and the folding device and the step of folding the blank around the mandrel is thus carried out by abutting opposed surfaces of the blank respectively with an abutment surface of the mandrel and with the folding device of the packaging unit.

The Applicant has pointed out that if, when the first folding is carried out, the blank and the folding device are not correctly positioned, a box of good quality is not obtained because the blank is not correctly folded along the folding lines, or rippings or tears in the blank or splashes of glue are generated.

The Applicant has verified that even minimal displacements with respect to the desired mutual position between the folding device and the blank can cause one or more of the drawbacks complained about above and therefore affect the quality of the box obtained.

The Applicant has therefore imagined using blank feed devices configured to precisely position the blank between the mandrel and the folding device.

The Applicant has, however, verified that the possibility of using such feed systems was limited by the required productivity.

In particular, the Applicant has verified that such a solution would not have been implementable in the known packaging apparatuses.

The Applicant has also hypothesized to slow down the packaging process to improve the folding of the blank on the mandrel. However, this solution has not proved to be implementable due to the required productivity limits.

The Applicant has therefore understood that in order to limit the possibility of tears of the blank or plashes of glue it was necessary to rethink the folding device. The Applicant has in fact noted that it was necessary to rethink the capability of effectively abutting the blank to wrap it around the mandrel to form a box without causing unwanted damages to the blank prior to folding.

The Applicant has realised that it was advantageous to be able to adjust the mutual position between the blank and the folding device at the time of abutting the blank with the folding device in order to be able to optimally fold the blank around the mandrel.

The Applicant has perceived that by adjusting the position of the folding device it is possible to adjust the folding of the blank around the mandrel.

On the basis of this insight, the Applicant has finally found that a method and a packaging unit for packaging articles in boxes that provides for using a folding device configured to abut said blank when the blank is positioned between the mandrel and the folding device and an adjustment device for modifying the position of the folding device surprisingly allow to adjust the folding conditions of the blank around the mandrel so as to better adapt them to the different operating conditions of the process, in order to fold the blank in the desired position and to obtain a high folding precision.

In other words, the Applicant has found that by adjusting the position of the folding device it is possible to modify in a significant way the dynamics of the impact between the blank and the folding device adapting the folding process to the characteristics of the blank, such as for example the dimensions, the thickness, the material, the quantity, the application position and the type of glue used, as well as to the characteristics of the mandrel, such as for example the dimensions, the speed, the trajectory, thus optimising the step for folding the blank and avoiding unwanted smears of the glue and at the same time maintaining high production speeds for each type of package.

In a first aspect thereof, therefore, the present invention concerns a packaging unit for packaging articles in boxes.

Preferably said packaging unit comprises a support frame.

Preferably, said packaging unit comprises a mandrel configured to accommodate one of said articles inside it.

Preferably said packaging unit comprises a movement device configured to move said mandrel with respect to said frame along a movement trajectory of the mandrel.

Preferably said packaging unit comprises a feed device configured to feed a blank towards said mandrel along a feeding trajectory which intersects said movement trajectory.

Preferably said packaging unit comprises a folding device mounted on the frame at said movement trajectory and configured to cooperate with said mandrel to fold said blank around said mandrel and to form one of said boxes.

Preferably said folding device comprises a folding element configured to abut said blank when said blank is positioned between said mandrel and said folding element.

Preferably said packaging unit comprises an adjustment device for modifying the position of said folding element with respect to said frame so as to adjust the folding of the blank around said mandrel.

In a second aspect thereof the present invention concerns a method for packaging articles in boxes.

Preferably, said method comprises depositing at least one of said articles in a mandrel.

Preferably, said method comprises moving said mandrel along a movement trajectory at a desired movement speed.

Preferably, said method comprises displacing a blank towards the mandrel by means of a feed device and positioning said blank along said movement trajectory of said mandrel in an advanced position with respect to said mandrel.

Preferably, said method comprises abutting said blank with a first abutment surface of said mandrel.

Preferably, said method comprises providing a folding device at said movement trajectory the folding device being mounted on a frame and configured to cooperate with the mandrel to fold said blank around the mandrel, when the blank is positioned between said mandrel and said folding device.

Preferably, said method comprises further abutting said blank with a folding element of said folding device on the opposite side with respect to said mandrel to fold said blank around said mandrel.

Preferably said method comprises modifying the position of said folding element with respect to said frame so as to adjust the folding of the blank around said mandrel.

In a third aspect thereof, the present invention concerns a method for carrying out a format change in the packaging of articles in boxes.

Preferably, said method comprises depositing at least one of said articles in a first mandrel.

Preferably, said method comprises moving said first mandrel along a movement trajectory at a desired movement speed.

Preferably, said method comprises displacing a first blank towards said first mandrel by means of a feed device and positioning said first blank along said movement trajectory of said first mandrel in an advanced position with respect to said first mandrel.

Preferably, said method comprises providing a folding device at said movement trajectory the being folding device mounted on a frame configured to cooperate with said first mandrel to fold said first blank around said first mandrel when said first blank is positioned between said first mandrel and said folding device.

Preferably, said method comprises abutting said blank with a first abutment surface of said first mandrel.

Preferably, said method comprises further abutting said blank with a folding element of said folding device on the opposite side with respect to said first mandrel to fold said blank around said first mandrel to fold said first blank around said first mandrel, so as to form a first box containing one of said articles.

Preferably said method comprises replacing said first mandrel with a second mandrel having dimensions different from said first mandrel and/or replacing said first blank with a second blank having dimensions different from said first blank, so as to change the format of said boxes.

Preferably said method comprises modifying the position of said folding element with respect to said frame as a function of the dimensions of said second blank and/or of said second mandrel.

Preferably, said method comprises repeating the above-mentioned steps with said second blank in place of said first blank and said second mandrel in place of said first mandrel so as to form a second box, different from said first box, containing one of said articles.

Thanks to these characteristics, the method and the packaging unit according to the present technical solution allow to effectively fold a blank around a mandrel avoiding that the blank is torn in the folding, without however penalising the production speed. Thanks to these characteristics, it is also possible to avoid or limit smears of the glue applied on the blank. Thanks to these characteristics it is therefore possible to obtain boxes of high quality level and at the same time to obtain high production speeds.

By modifying the position of the folding device with respect to the frame, it is possible to modify the way in which the blank is folded on the mandrel and thus to adjust the folding of the blank on the mandrel. The impact force applied to the blank by the folding device can be modified by avoiding, or in any case drastically limiting, the occurrence of any damages to the blanks. It is in fact possible to fold the blank around the mandrel in a longer time, therefore in a gentler way, or in a shorter time if desired.

These advantages are obtained without the need to decrease the movement speed of the mandrel and, therefore, the productivity of the packaging unit.

In a fourth aspect thereof, therefore, the present invention concerns a packaging unit for packaging articles in boxes.

Preferably said packaging unit comprises a support frame.

Preferably, said packaging unit comprises a mandrel configured to accommodate one of said articles inside it.

Preferably said packaging unit comprises a movement device configured to move said mandrel with respect to said frame along a movement trajectory of the mandrel.

Preferably said packaging unit comprises a feed device configured to feed a blank towards said mandrel along a feeding trajectory which intersects said movement trajectory.

Preferably said packaging unit comprises a folding device mounted on the frame at said movement trajectory and configured to cooperate with said mandrel to fold said blank around said mandrel and to form one of said boxes.

Preferably said folding device comprises a folding element configured to abut said blank when said blank is positioned between said mandrel and said folding element so as to form one of said boxes.

Preferably, said folding element is provided with at least one opening intended to at least partially house said feed device when said feed device is interposed between said mandrel and said folding device.

In a fifth aspect thereof the present invention concerns a method for packaging articles in boxes.

Preferably, said method comprises depositing at least one of said articles in a mandrel.

Preferably, said method comprises moving said mandrel along a movement trajectory.

Preferably, said method comprises displacing a blank towards the mandrel by means of a feed device and positioning said blank along said movement trajectory of said mandrel in an advanced position with respect to said mandrel.

Preferably, said method comprises abutting said blank with a first abutment surface of said mandrel.

Preferably, said method comprises providing a folding device at said movement trajectory the folding device mounted on a frame and configured to cooperate with the mandrel to fold said blank around the mandrel, when the blank is positioned between said mandrel and said folding device.

Preferably said method comprises displacing said feed device along said movement trajectory towards said folding element.

Preferably said method comprises at least partially accommodating said feed device in at least one opening obtained in said folding element.

Preferably, said method comprises further abutting said blank with a folding element of said folding device on the opposite side with respect to said mandrel to fold said blank around said mandrel.

Preferably said method comprises releasing said blank from said feed device.

Thanks to these characteristics, the method and the packaging unit according to the present technical solution make it possible to effectively fold a blank around a mandrel avoiding on the one hand potential interferences between the components of the packaging unit and ensuring at the same time that boxes having a regular and precise shape are formed. Thanks to these features it is also possible to obtain the aforementioned advantages without penalising the production speed.

By at least partially accommodating the feed device in the at least one opening of the folding device it is possible to more precisely position the blank between the mandrel and the folding device. It is in fact not necessary to suddenly move the feed device away from the movement trajectory in order to avoid interferences between the folding device and the feed device.

It is also possible to adjust the release position of the blank by the feed device without thereby creating interferences between the feed device and the folding device. It is in fact not necessary to release the blank before the impact with the folding device or to suddenly remove the folding device from the movement trajectory to avoid interferences with the folding device.

In addition, it is possible to accompany the blank with the folding device for a stroke of the movement trajectory and, therefore, improve the positioning of the blank between the mandrel and the folding device.

These advantages are obtained without the need to decrease the movement speed of the mandrel and, therefore, the productivity of the packaging unit.

In a sixth aspect thereof, therefore, the present invention concerns a packaging unit for packaging articles in boxes.

Preferably said packaging unit comprises a support frame.

Preferably, said packaging unit comprises a mandrel configured to accommodate one of said articles inside it.

Preferably said packaging unit comprises a movement device configured to move said mandrel with respect to said frame along a movement trajectory of the mandrel.

Preferably said packaging unit comprises a feed device configured to feed a blank towards said mandrel along a feeding trajectory which intersects said movement trajectory.

Preferably said packaging unit comprises a folding device mounted on the frame and configured to cooperate with said mandrel to fold said blank around said mandrel.

Preferably said folding device comprises a folding element configured to abut said blank when said blank is positioned between said mandrel and said folding element so as to form one of said boxes.

Preferably, said folding element comprises a first impact surface of said blank against said folding device having an arched shape, convex towards said blank with a radius of curvature comprised between about 100 mm and about 1000 mm.

Preferably, said first impact surface is developed over an angle greater than 20°.

In a seventh aspect thereof the present invention concerns a method for packaging articles in boxes.

Preferably, said method comprises depositing at least one of said articles in a mandrel.

Preferably, said method comprises moving said mandrel along a movement trajectory.

Preferably, said method comprises displacing a blank towards the mandrel by means of a feed device and positioning said blank along said movement trajectory of said mandrel in an advanced position with respect to said mandrel.

Preferably, said method comprises abutting said blank with a first abutment surface of said mandrel.

Preferably, said method comprises providing a folding device configured to cooperate with the mandrel to fold said blank around the mandrel.

Preferably, said method comprises folding said blank on said mandrel with a folding element when said blank is positioned between said mandrel and said folding device.

Preferably, said folding further comprises abutting said blank with a first impact surface of said blank against said folding device having an arched shape, convex towards said blank with a radius of curvature comprised between about 100 mm and about 1000 mm and developed over an angle greater than 20°.

Thanks to these characteristics, the method and the packaging unit according to the present technical solution allow to effectively fold a blank around a mandrel avoiding that the blank is torn in the folding, without however penalising the production speed. Thanks to these features, it is also possible to avoid or limit smears of the glue present and applied on the blank. Thanks to these characteristics it is therefore possible to obtain boxes of high quality level and at the same time to obtain high production speeds.

The configuration of the folding element such that the first impact surface has an arched shape, convex towards said blank with a radius of curvature comprised between about 100 mm and about 1000 mm and developed over an angle greater than 20° allows the blank to be gradually folded by progressively guiding it towards the mandrel. The provision of a first impact surface having a radius of curvature in the provided range avoids jamming of the blank, moreover using a first impact surface developed over an angle greater than 20° the blank is progressively guided from the planar configuration to the configuration folded on the mandrel. This configuration of the first impact surface makes it possible to fold the blank on the mandrel so as to obtain a box with regular shape.

This configuration of the first impact surface allows to progressively guide the blank from the planar feeding configuration towards the mandrel by correctly folding the blank on the mandrel. This configuration makes it possible to obtain high quality boxes.

These advantages are obtained without the need to decrease the movement speed of the mandrel and, therefore, the productivity of the packaging unit.

The present invention, in at least one of the aforementioned aspects, may have at least one of the further preferred features set forth below.

In some versions, said packaging unit comprises an adjustment device for modifying the position of said folding element with respect to said frame so as to adjust the folding of the blank around said mandrel.

Preferably, said adjustment device comprises a first adjustment element for modifying the inclination of said folding element with respect to said movement trajectory. In this way it is possible to adjust the folding speed of the blank, i.e. the space and the time necessary to bring the blank from the planar configuration to the configuration wrapped on the mandrel.

Preferably said movement device is configured to move said mandrel on an advancement plane of the mandrel. Preferably said advancement plane is a horizontal plane.

Preferably said first adjustment element is configured to modify the inclination of said folding element with respect to said advancement plane.

The folding element can be constrained by a hinge to the frame so as to be oscillatable with respect to the advancement plane.

Preferably, said adjustment device comprises a second adjustment element for displacing said folding element along at least one direction transversal to said movement trajectory. By displacing the folding element transversely to the movement trajectory, it is possible to modify the extension of the blank that is abutted by the folding element, or the portion of the blank that is abutted by the folding element. It is possible to displace said folding element, for example, to abut a central portion of the blank, avoiding for example that the blank is abutted non-symmetrically on the mandrel. It is possible to displace said folding element, for example, to abut more peripheral portions of the blank, avoiding for example that peripheral flaps with large dimensions are not abutted by the folding element being damaged.

In some versions, the second adjustment element is configured to displace said folding element along said direction transversal to said movement trajectory parallel to the advancement plane of said mandrel.

In some versions, the second adjustment element is configured to displace said folding element along said direction transversal to said movement trajectory transversely to the advancement plane of said mandrel. The possibility of displacing the folding element with respect to the advancement plane of the mandrel allows to limit or avoid interferences with the folding device.

Preferably, said adjustment device comprises a third adjustment element for displacing said folding element along a direction parallel to said movement trajectory. By displacing the folding element parallel to the movement trajectory, it is possible to modify the point of the movement trajectory in which the blank abuts the folding device.

In some versions, the third adjustment element is configured to displace said folding element along said direction parallel to said movement trajectory parallel to the advancement plane of said mandrel.

In some versions, the third adjustment element is configured to displace said folding element along said direction parallel to said movement trajectory transversely to the advancement plane of said mandrel.

Preferably, said adjustment device comprises an adjustment member for displacing said folding element along at least one direction transversal to said movement trajectory. The possibility of displacing the folding element with respect to the advancement plane of the mandrel allows to avoid interferences with the folding device.

Preferably, said adjustment device comprises a second adjustment member for displacing said folding element along a direction parallel to said movement trajectory.

Preferably, said adjustment device comprises a third adjustment member for modifying the inclination of said folding element with respect to the advancement plane of the mandrel.

Preferably, the folding element comprises an arm constrained to a frame of the packaging unit.

The folding element or the arm of the folding element can be constrained to a movement belt, or to a system of toothed wheels, or even a pin movable in a sliding slot, or even an articulated polygon movement mechanism, so as to be translated along a direction transversal or parallel to the movement trajectory.

Preferably, said folding element defines a first impact surface, for the abutment of said blank with said folding device. The first impact surface corresponds to the surface of the folding element on which the blank touches the folding device.

Preferably, said first impact surface has an arched shape. Preferably, said first impact surface has a shape convex towards said blank. This measure allows to protect the blank in the contact between the folding device and the blank, avoiding jamming and fractures.

Preferably, said first impact surface has a profile shaped like an arc of circumference. Preferably the radius of the arc of circumference lies on a surface perpendicular to the movement trajectory.

Preferably said radius of curvature is comprised between about 200 mm and about 500 mm.

Preferably, said first impact surface has a profile shaped like an arc of circumference defined by a radius comprised between about 100 mm and about 1000 mm, preferably between about 200 mm and about 500 mm. By using a folding device having a first impact surface shaped like an arc of circumference defined by a radius having dimensions in the above-mentioned range it is possible to obtain a gradual and gentle folding of the blank. These values of the radius of curvature allow to optimally fold the blank avoiding tears or splashes of glue. It is possible to gradually accompany the blank from the planar configuration in which it is fed by the feed device to the wrapping position around the mandrel, obtaining boxes with very precise shape.

Preferably, said first impact surface having a profile shaped like an arc of circumference is developed over an angle greater than 20°, preferably greater than 30°. Preferably said first impact surface has a profile shaped like an arc of circumference is developed over an angle of less than 90°.

Preferably said angle is greater than 30°.

Preferably said angle is less than 90°.

Preferably said first impact surface has an extension measured in a direction transversal to the movement trajectory comprised between about 30% and about 100%, preferably between about 60% and about 90% of the width of the blank.

Preferably said first impact surface has an extension measured in a direction transversal to the movement trajectory greater than the width of the blank.

In some versions, said folding element is provided with at least one opening intended to at least partially house said feed device when interposed between said mandrel and said folding device. The presence of such an opening allows to improve the positioning of the blank between the mandrel and the folding device and the passage of the blank from the feed device to the folding device.

Preferably, said feed device comprises at least one retaining element for retaining said blank intended to be coupled at least partially to said at least one opening.

Preferably, said feed device comprises a plurality of retaining elements intended to be coupled to distinct portions of said blank for feeding it towards said mandrel.

Preferably, said at least one retaining element comprises at least one suction cup operatively connected to a suction device.

In other versions, various retaining elements may be provided, such as for example grippers engaged in desired portions of the blank, belts or movement belts to carry the blank towards the mandrel, the folding element being configured so as to at least partially house the retaining elements used.

Preferably, the folding element comprises a plurality of prongs intended to abut the blank. Preferably, two adjacent prongs of said plurality of prongs are separated by said at least one opening. The prongs are positioned on the folding element so as to each comprise a surface portion of the first impact surface. The first impact surface of the folding element is therefore formed by various first impact surface portions, each first impact surface portion being defined by a prong of the plurality of prongs.

Preferably, said folding prongs of said plurality of prongs are positioned so that a radially outer prong is further backward with respect to said movement trajectory than another prong of said plurality of prongs that is positioned radially inner than the radially outer prong.

Preferably said folding element comprises a plurality of prongs defining said first impact surface. In this case each prong defines a portion of said first impact surface, said first impact surface being formed by a plurality of first impact surface portions.

In some versions, said adjustment device is configured to modify the position of at least one prong of said plurality of prongs to modify the position and/or the width of said at least one opening.

In some versions, said unit comprises an adjustment member for adjusting the position of at least one prong of said plurality of prongs with respect to another prong of said plurality of prongs. This allows to modify the position and the dimension of the at least one opening, and it is further possible to modify the shape and the configuration of the first impact surface.

Preferably, said adjustment device comprises a first adjustment member for adjusting the inclination of said at least one prong of said plurality of prongs with respect to an advancement plane of said mandrel.

For example, the prongs may be constrained by a hinge to the base or to the arm so that they are oscillatable with respect to the advancement plane.

Preferably, said adjustment device comprises a second adjustment member for displacing said at least one prong of said plurality of prongs along a direction transversal to said movement trajectory. Preferably said second adjustment member is configured to displace said at least one prong along said direction transversal to said movement trajectory parallel to the advancement plane of the mandrel.

Preferably, said adjustment device comprises a third adjustment member for displacing said at least one prong of said plurality of prongs along a direction parallel to said movement trajectory. Preferably said third adjustment member is configured to displace said at least one prong along said direction parallel to said movement trajectory parallel to the advancement plane of the mandrel.

The prongs can be constrained to movement belts, or to a system of toothed wheels, or even a pin movable in a sliding slot, or even a pin movable in a sliding slot, or even an articulated polygon movement mechanism, so as to be translated along a direction transversal or parallel to the movement trajectory.

Preferably, said folding prongs of said plurality of prongs are positioned so that a radially outer prong is further backward with respect to said movement trajectory than another prong of said plurality of prongs that is radially innermost than the radially outer prong.

In some versions it is provided for displacing the prongs with respect to the base in order to modify the width of the opening defined between the prongs.

In other versions the folding element may comprise a single plate defining the first impact surface.

In other versions, the folding element is formed by a single plate provided with at least one opening and intended to abut the blank.

Preferably, said plurality of prongs is constrained in an adjustable manner to a base of said folding element. In this way it is possible to modify the position of the first impact surface. For example, the prongs may be constrained by a hinge to the base or to an arm so that they are oscillatable with respect to the advancement plane.

The prongs can be constrained to movement belts, or to a system of toothed wheels, or even a pin movable in a sliding slot, or even a pin movable in a sliding slot, or even an articulated polygon movement mechanism, so as to be translated along a direction transversal or parallel to the movement trajectory

In some versions it is provided for displacing the prongs together with the base with respect to the frame in order to modify the width and/or the position of the at least one opening defined between the prongs

In some embodiments, the position of at least one prong of said plurality of prongs is adjustable with respect to the position of at least another prong of said plurality of prongs. In this way it is possible to modify the position, the shape and the dimensions of the first impact surface.

Preferably, said folding element comprises a plurality of openings, each opening being suitable to be coupled to a respective retaining element. In this way it is possible to optimise the positioning of the blank between the mandrel and the folding device. It is possible to accompany the blank with the feed device towards the folding device.

Preferably, said folding element comprises a plurality of openings, the openings of said plurality of openings being spaced apart along a direction transversal to said movement trajectory.

In some versions, said movement trajectory has a circular shape.

In some versions the prongs of said plurality of prongs are arranged such that the openings of said plurality of openings are aligned along a radial direction of said movement trajectory.

In some versions the prongs of said plurality of prongs are arranged such that the openings of said plurality of openings are misaligned along a radial direction of said movement trajectory.

Some openings may be in a further advanced position along the movement trajectory than other openings of said plurality of openings.

Preferably, said radius of curvature of said surface of curvature is variable along a transverse direction of said movement trajectory so as to define a first impact surface in the form of a conical surface portion. By varying the radius of curvature of the first impact surface, a first impact surface in the form of a conical surface portion is obtained. This configuration of the first impact surface makes it possible to fold irregularly sized blanks more evenly. This configuration makes it possible to optimise the folding of the blank in the event of a curvilinear movement trajectory.

Preferably, said movement device is configured to rotate said mandrel around an axis of rotation defining a movement trajectory shaped like an arc of circumference.

In some versions said movement device is configured to rotate said mandrel around an axis of rotation defining a movement trajectory shaped like an arc of circumference and wherein said folding element is configured so that said first impact surface extends along a direction parallel to the radial direction of said mandrel passing through the point of abutment of said blank with said folding element.

Preferably said radial direction intersects the first impact surface at a radially outer portion. The folding element is positioned so that at the point of abutment the blank abuts the first impact surface at a radially outer portion of the first impact surface. In such a case, the folding element is positioned so that at the point of abutment the blank abuts the first impact surface at a radially outer portion of the first impact surface. In this way, progressively, the blank is approached towards the surface of said folding element and is correctly folded towards the mandrel. The radially inner portion of the first impact surface is further advanced than a radially outer portion with respect to the movement trajectory. At the point of abutment, the blank abuts the first impact surface at a radially outer portion thereof and along the movement trajectory the blank progressively aligns with the first impact surface approaching the radially innermost portions thereof.

Preferably, said movement device is configured to rotate said mandrel around an axis of rotation defining a circular movement trajectory.

Preferably, said radius of curvature is variable along a radial direction of said movement trajectory passing through said first impact surface.

In some versions, said radius of curvature decreases along said radial direction from the outside towards said axis of rotation.

Preferably, said first impact surface is shaped like a conical surface portion having an axis extended parallel to said radial direction and whose vertex belongs to the axis of rotation of said mandrel.

Preferably, said folding element is configured so that said first impact surface extends along the radial direction of said movement trajectory passing through the point of abutment of said blank with said folding element. In this case, at the point of abutment, the blank abuts the first impact almost over its entire width.

Preferably, said folding element is configured such that said first impact surface comprises a radial direction of said movement trajectory.

Preferably said radial direction passes through a radially central portion of said first impact surface. In this case, at the point of abutment, the blank is aligned with the first impact surface.

Preferably said radial direction intersects said first impact surface at a radially peripheral portion of said first impact surface. The central portion of the first impact surface is further backward than the peripheral portion with respect to the movement trajectory. In this case, at the point of abutment, the blank abuts the first impact surface at a radially peripheral portion thereof and is not aligned with the first impact surface. Along the movement trajectory the blank progressively aligns with the first impact surface approaching the radially innermost portions thereof.

In some versions, said first impact surface of said folding element has a conical shape with an axis extended along the radial direction of said movement trajectory at the point of abutment of said blank with said folding element and vertex substantially coincident with the centre of rotation of said movement trajectory.

In some versions, said radius of curvature of said surface of curvature is constant so as to define a first impact surface in the form of a cylindrical surface portion.

In some versions, said first impact surface of said folding element is shaped as a cylindrical surface portion, convex towards said blank. In other words, the first impact surface of said folding element has substantially constant radius of curvature. Preferably said first impact surface is positioned so that the axis of the cylinder is perpendicular to the movement trajectory and parallel to the advancement plane.

The folding element can be positioned, if the movement trajectory is linear, so that the axis of the cylindrical surface is perpendicular to the movement trajectory. In this case, the blank abuts the first impact surface over its entire width and is guided towards the mandrel evenly.

The folding element can be positioned so that the axis of the cylindrical surface is transversal to the movement trajectory.

In some versions, the packaging unit comprises a second folding element arranged on the opposite side with respect to an advancement plane of said mandrel, so that said folding element and said second folding element are arranged to respectively abut a first panel and a second panel of said blank that are provided on opposite sides of said blank with respect to the advancement plane defined by said mandrel when moved along said movement trajectory.

The provision of a second folding element makes it possible to optimise the folding of the blank around the mandrel. By abutting two distinct panels of the blank respectively with the folding element and the second folding element it is possible to simultaneously fold the two opposed panels around the mandrel preventing the blank from slipping or sliding with respect to the mandrel.

Preferably, said second folding element is positioned with respect to the movement trajectory in a position corresponding to said folding element so that said folding element and said second folding element abut said first panel and said second panel respectively substantially simultaneously. In this way, the first and second panel are folded substantially simultaneously on the mandrel preventing the blank from displacing with respect to the mandrel.

In one version, the second folding element is positioned with respect to the movement trajectory in a further advanced position than the folding element so that said second folding element abuts the second panel after the folding element has abutted the first panel and has started folding the first panel on the mandrel. In this way, it is possible for example to fold the first panel more slowly than the second panel. It may be possible to fold more slowly the panel on which the glue is applied to glue the box.

Preferably, said second folding element defines an impact surface for the abutment of said blank with said second folding element, said impact surface having an arched shape, preferably convex towards said blank.

Preferably, said second folding element comprises an impact surface for the abutment of said blank with said second folding element, said impact surface being inclined with respect to the movement trajectory.

Preferably, said impact surface comprises a first portion having an almost vertical position and at least one accompanying portion that is inclined with respect to the advancement plane, preferably with an inclination angle comprised between 15° and 45°, preferably about 30°.

In a preferred version, the packaging unit comprises a retaining device displaceable between an operating position in which the retaining device is approached to the first abutment surface of the mandrel to retain the blank against the first abutment surface and a non-operating position in which the retaining device is spaced apart from the first abutment surface.

Preferably, the packaging unit further comprises an operating member configured to displace the retaining device along an actuation trajectory to bring it towards the operating position.

Preferably the actuation trajectory comprises a transverse stroke arranged transversely to the movement trajectory of the mandrel. In this way the retaining device can be displaced with respect to the movement trajectory of the mandrel when not in use so as to avoid unwanted interferences with the mandrel.

The transverse stroke is preferably parallel to the advancement plane defined by the mandrel when moved along the movement trajectory. The actuation member is configured to displace the retaining device along an advancement trajectory having a transverse stroke parallel to the advancement plane.

In a preferred version the transverse stroke is perpendicular to the advancement plane defined by the mandrel when moved along the movement trajectory. The actuation member is configured to displace the retaining device along an advancement trajectory having a transverse stroke perpendicular to the advancement plane.

Preferably, the actuation trajectory comprises a thrust stroke arranged parallel to the movement trajectory of the mandrel.

In this way the retaining device can be approached to the mandrel to retain the blank against the mandrel.

In some preferred embodiments, the actuation trajectory is curvilinear, preferably, the trajectory comprises a circumferential stroke. The curvilinear actuation trajectory is arranged so that a transverse stroke arranged transversely to the movement trajectory of the mandrel and a thrust stroke arranged parallel to the movement trajectory of the mandrel can be identified.

Preferably, the actuation member is configured to displace the retaining device along an actuation trajectory in which the transverse stroke is arranged radially with respect to the movement trajectory of the mandrel.

In some versions said abutting is provided prior to said further abutting and said releasing is provided after said further abutting.

In some versions said abutting is provided prior to said further abutting and said releasing is provided prior to said further abutting and after said abutting.

In some versions said abutting is provided prior to said further abutting and said releasing is provided prior to said abutting.

In some versions of the method it is provided to modify the position of said folding element with respect to said frame so as to adjust the folding of the blank around said mandrel.

Preferably, it is provided to modify the position of said second folding element with respect to said movement trajectory.

In some versions, said modifying comprises positioning said first folding element and/or said second folding element so that said first folding element and said second folding element abut respectively said first portion and said second portion substantially simultaneously.

Preferably, said method comprises retaining said blank by suction.

In some versions, said modifying comprises displacing at least one prong of said plurality of prongs with respect to the position of at least another prong of said plurality of prongs.

In some versions, said modifying comprises displacing at least one prong of said plurality of prongs to modify the dimensions and/or the position of said at least one opening.

In some versions, said modifying comprises displacing at least one prong of said plurality of prongs with respect to a base of said folding element to which said at least one prong is constrained in an adjustable manner.

In some versions, said modifying comprises displacing at least one prong of said plurality of prongs so as to define a first impact surface of said folding element having a cylindrical shape, convex towards said blank. Preferably, said first impact surface is configured so that the axis of rotation of said cylindrical surface lies in a plane parallel to the advancement plane defined by said mandrel. Preferably said radius is parallel to a radial direction of said movement trajectory passing through said abutment position.

Preferably, said method comprises displacing at least one prong of said plurality of prongs. Preferably, it is provided for displacing at least one prong of said plurality of prongs with respect to another prong of said plurality of prongs.

Preferably, it is provided for displacing at least one prong of said plurality of prongs along a direction transversal to said movement trajectory.

Preferably, it is provided for displacing at least one prong of said plurality of prongs along a direction transversal to said movement trajectory parallel to the advancement plane of the mandrel.

Preferably, it is provided for displacing at least one prong of said plurality of prongs along a direction parallel to said movement trajectory.

Preferably, it is provided for displacing at least one prong of said plurality of prongs along a direction parallel to said movement trajectory parallel to the advancement plane of the mandrel.

In some versions, said modifying comprises displacing at least one prong of said plurality of prongs so as to define a first impact surface of said folding element having a conical shape with an axis extended along the radial direction of said movement trajectory and vertex substantially coincident with the centre of rotation of said movement trajectory.

Preferably, said modifying comprises displacing said folding element with respect to said frame so as to adjust the position of said at least one opening with respect to said feed device.

Preferably, said modifying comprises modifying the position of said at least one opening along a direction transversal to said movement trajectory.

In some versions, said modifying comprises moving at least one prong of said plurality of prongs along a direction transversal to said movement trajectory.

In some versions, said modifying comprises moving at least one prong of said plurality of prongs along a direction parallel to said movement trajectory.

In some versions, said modifying comprises oscillating at least one prong of said plurality of prongs along a direction transversal to said advancement plane.

Preferably, said movement comprises rotating said mandrel around an axis of rotation defining a movement trajectory shaped like an arc of circumference.

Preferably said folding comprises further abutting said blank with a first impact surface having a constant radius of curvature.

Preferably, said method comprises modifying the position of said folding element with respect to said frame.

It should be noted that some steps of the method described above may be independent of the order of execution reported. In addition, some steps may be optional. In addition, some steps of the methods may be performed repetitively, or they may be performed in series or in parallel with other steps of the method.

The features and advantages of the invention will become clearer from the detailed description of a preferred embodiment thereof, by way of non-limiting example, with reference to the appended drawings wherein:

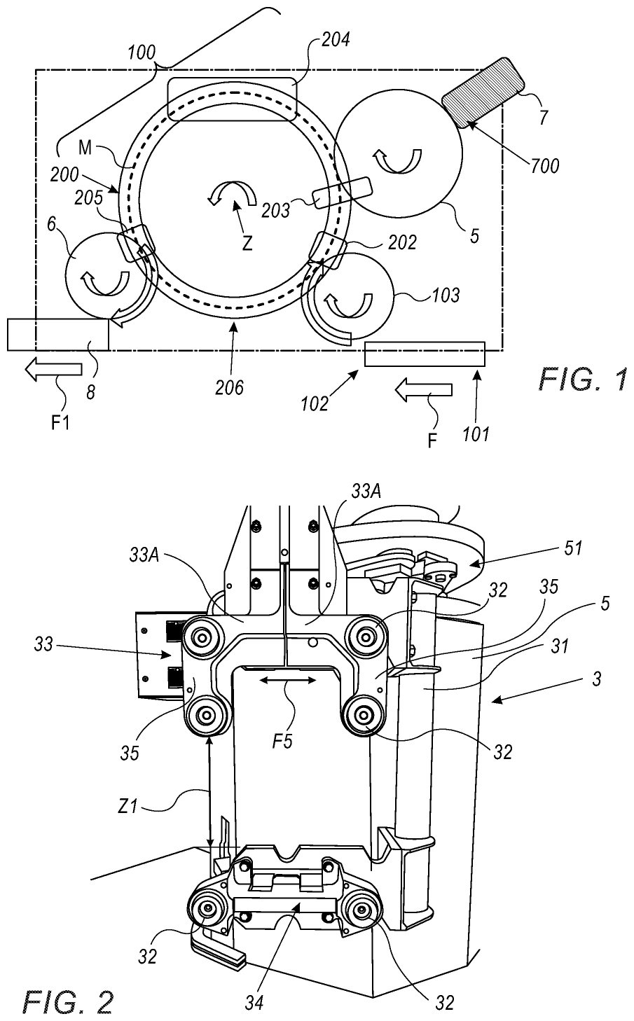

FIG. 1 is a schematic plan view of an embodiment example of a packaging unit in accordance with the present solution;

FIG. 2 is a partial schematic view of a version of a feed device of the packaging unit of FIG. 1;

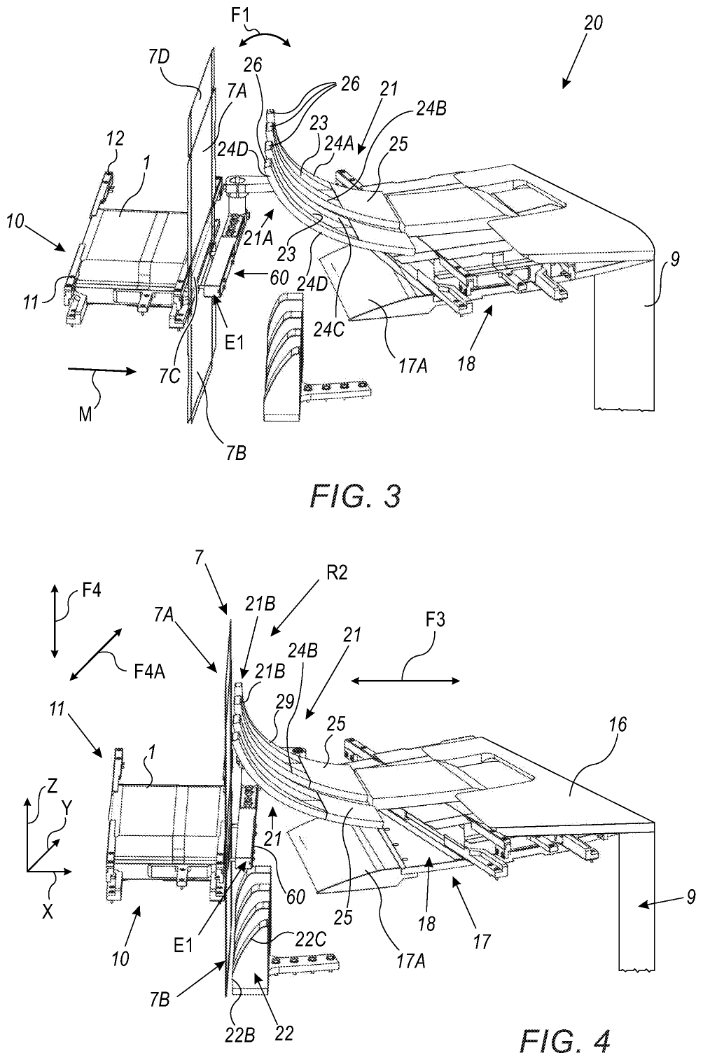

FIGS. 3-4 are partial schematic views of a version of a folding device and of a mandrel of the packaging unit of FIG. 1 and of a blank in two distinct positions of use;

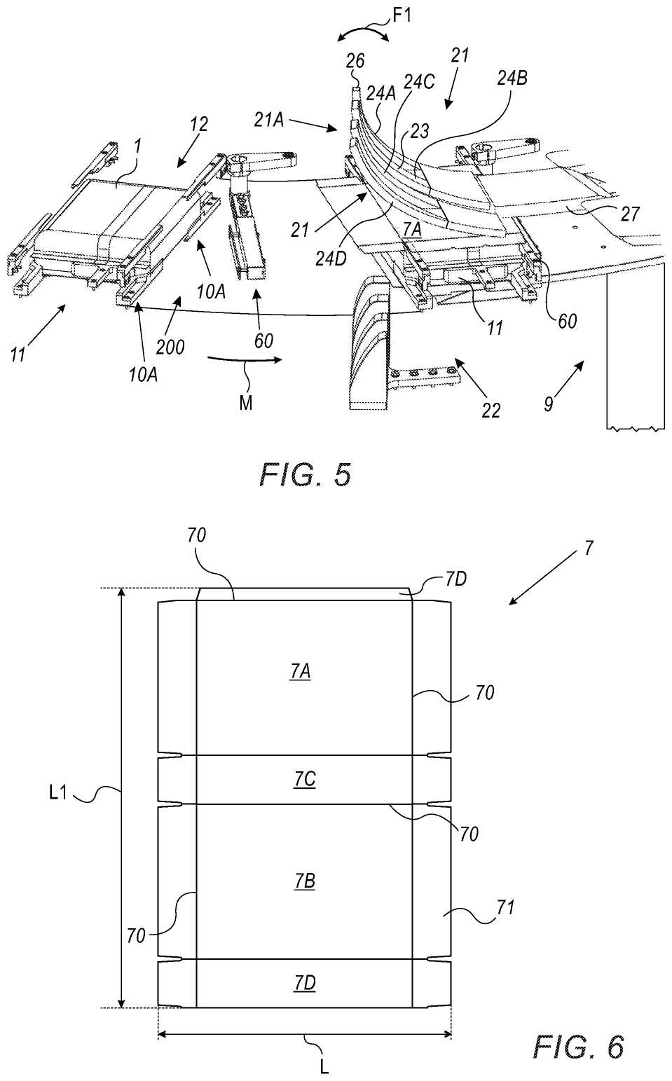

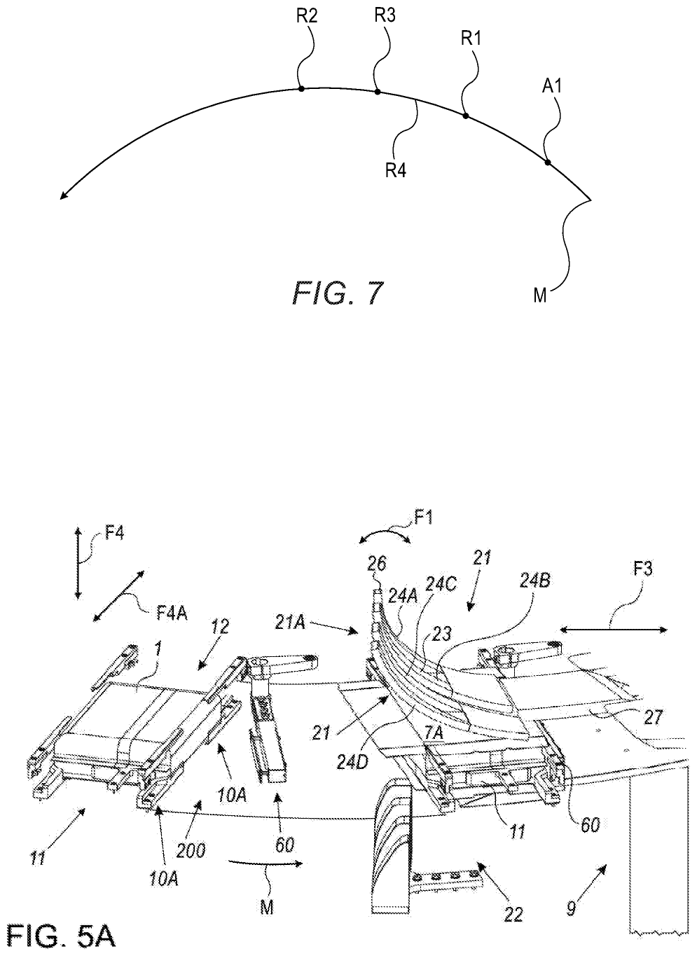

FIG. 5 is a partial schematic view of another version of a folding device and of a mandrel of the packaging unit of FIG. 1 and of a blank in a position of use;

FIG. 6 is a schematic view of a usable blank of the packaging unit of FIG. 1;

FIG. 7 is a schematic graph of a part of the movement trajectory of a mandrel of the packaging unit of FIG. 1;

FIG. 5A is a partial schematic view of another version of a folding device and of a mandrel of the packaging unit of FIG. 1 and of a blank in a position of use.

In the accompanying figures, a packaging unit made in accordance with this solution is indicated as a whole with 100. The packaging unit 100 is of the “wrap-around” type, performing the packaging by wrapping a box around an article 1 to be packaged. In the present example, article 1, better visible in FIGS. 3-5, consists of one or more flexible bags, filled with predetermined quantities of bulk products in the form of a discrete particulate consisting of granules and/or corn flakes and suitably sealed. The box 2 is formed by wrapping a blank 7, better visible in FIG. 6, around a mandrel 10 bearing the article 1, as better clarified below.

The packaging unit 100 is fed by a straight conveyor belt 101 on which the articles 1 to be packaged are conveyed, which in the present example consist of the bags described above, coming from the respective filling and sealing plant. The conveyor belt 101 transports the articles 1 in the direction indicated by the arrow F to a first unloading end 102 at which the articles 1 are picked up by a transfer carousel 103 which is provided to pick up an article 1 to be packaged from the conveyor belt 101 and transfer it to the packaging unit 100 in which the execution of a wrapping step of a box is provided, as better clarified below.

The packaging unit 100 comprises in its more general units a forming carousel 3 which is provided to receive the articles 1 from the transfer carousel 103 and to form a box 2, a feed carousel 5 for feeding blanks 7 to the forming carousel 3 and an outlet carousel 6, intended to pick up the boxes 2 formed by the forming carousel 3 and to deposit them on an evacuation belt 8 through which the boxes 2 are transported to subsequent processing units provided in the packaging unit 100.

The forming carousel 3, the feed carousel 5 and the outlet carousel 6 are brought into rotation, by means of respective movement devices not shown, in order to be rotatable about respective axes of rotation substantially parallel to a vertical direction, indicated in the figures generally with Z perpendicular to the plane of FIG. 1.

Each mandrel 10 is carried along the movement trajectory M between a receiving zone 202, in which the mandrel 10 receives an article 1 from the transfer carousel 103, an abutment zone 203, in which the mandrel 10 abuts a blank 7 supplied by the feed device 30 in a first abutment position R1, a forming zone 204, in which the blank 7 is folded on the mandrel by means of a folding device 20 so as to form a box 2 containing the article 1, an unloading zone 205, in which the box 2 containing the article 1 is deposited on the outlet carousel 6 and, finally, a return zone 206 in which the mandrel 10 is returned to the receiving zone 202. From the exit carousel 6, the box 2 is then deposited on the evacuation belt 8 to be transported to the subsequent processing stations.

The forming carousel 3 comprises a frame 9, or other support structure for ground support, to which a plurality of mandrels 10 are constrained. Each mandrel 10 is configured to accommodate one of the articles 1 inside it and is operatively connected to a movement device of the forming carousel 3 to be displaced along the movement trajectory M. The movement trajectory M lies on an advancement plane 200 of the mandrel 10 and is a line oriented in the shape of an arc of circumference. The advancement plane of the mandrel is a horizontal plane with XY orientation in an orthogonal Cartesian reference system XYZ, as shown in FIG. 4.

The mandrel 10 comprises a first unit 11 and a second unit 12, distinct and separated from each other, and positioned so as to define an accommodation seat for an article 1 to be transported. Advantageously, the first unit 11 and the second unit 12 are displaceable with respect to each other so as to define an accommodation seat with variable dimensions for the articles 1.

The mandrel 10 further comprises a first abutment surface 10A defined as the surface of the mandrel 10 intended to abut the blank 7 as first when the latter is positioned in the movement trajectory M. The first abutment surface 10A is the surface of the mandrel 10 provided in the further advanced position along the movement trajectory M.

The blank 7, better visible in FIG. 6, is made of cardboard with a thickness comprised between 0.4 and 0.8 mm, in this case about 0.5 mm, a width “L” and a length “L1” which are chosen according to the dimensions of the box 2 to be formed when folded around the mandrel 10. For this purpose, folding lines 70 are obtained on the blank 7 that divide the blank 7 into a plurality of panels 71 intended to form, alone or in combination with each other, the different faces of the box 2. The folding lines 70 are preferably creases and the panels 71 of each pair of adjacent panels are oscillatable about a respective folding line 70 that separates them. In particular, in the blank 7, an intermediate panel 7C, as well as a first and a second panel 7A, 7B extended respectively on two opposed sides of the intermediate panel 7C, and separated therefrom by respective folding lines 70 and an edge 7D on which a desired quantity of glue is applied for closing the box 2 are identified.

The first and second panels 7A, 7B are intended to form two opposed faces of the box 2. The first and second panels 7A, 7B are intended to be folded on the mandrel 10 on opposite sides with respect to the advancement plane 200, as better clarified below. The blank 7 is fed to the forming carousel 3 so that the length L1 is parallel to the direction perpendicular to the advancement plane 200 of the mandrel, i.e. in the present version, parallel to the vertical axis Z, while the width L is parallel to the advancement plane 200 of the mandrel.

The feeding carousel 5 comprises a plurality of feed devices 30, each feed device 30 is configured to pick up a single blank 7 from a group of blanks stacked in a hopper 700 and move it along a feeding trajectory which intersects the movement trajectory M in the position A1 to feed it towards a mandrel 10 of the forming carousel 3. Furthermore, an application device not visible in the Figures is provided, which is intended to apply a desired amount of glue on the edge portion 7D of the blank 7, when the blank 7 is retained on a feed device 30 before feeding it to the forming carousel 3.

Each feed device 30, shown in greater detail in FIG. 2, comprises a plurality of retaining elements arranged to retain the blank 7 in different portions thereof. In the version shown, the feed device 30 comprises a support structure 31 to which two upper retaining elements 33 configured to retain the first panel of the blank 7A are fixed, and a lower retaining element 34 intended to retain the second panel 7B of the blank 7. The support structure 31 is constrained to a frame 51 of the feed carousel 5 in a displaceable manner to move the blank 7 to the forming carousel 3.

Each upper retaining element 33 comprises an “L” shaped body having a hooking portion 33A fixed to the support structure 31 and an appendage 35 projecting from the hooking portion 33A and provided with two suction cups 32. The appendage 35 comprises a pair of suction cups 32, each suction cup being operatively connected to a suction device, not visible in the figures, and arranged to retain in a releasable manner a desired portion of the blank 7. Each appendage 35 is intended to be housed in an opening 23 defined on the folding device 20, as better explained below.

The appendages 35 are mutually spaced apart to engage distinct portions of the top panel 7A of the blank 7. The two upper retaining elements 33 are displaceable in both directions of the arrow F5 so as to adjust the distance between the appendages 35 and, therefore, between the suction cups 32. This allows to improve the retention of the blank 7 by the upper retaining element 33 and the feeding of the blank 7 to the forming carousel 3, as better clarified below.

The lower retaining element 34 is provided with two suction cups 32, also operatively connected to a suction device in order to retain in a releasable manner the blank 7. The upper retaining elements 33 and the lower retaining element 34 are intended to be moved respectively above and below the advancement plane 200 and at a certain distance therefrom. In particular, the lower retaining element 34 is placed at a desired vertical distance Z1 from the appendages 35 of the upper retaining elements 33. The support structure 31 is configured so as to be moved externally to the advancement plane 200 of the mandrel 10. These measures make it possible to facilitate the movement of the mandrel 10 and of other components of the packaging unit 100, as better clarified below. The possibility of interferences between the mandrel 10 and the feed device 30 is reduced and the abutment of the blank 7 with the folding device 20 is improved.

According to some technical solutions each retaining element comprises at least one suction cup 32 operatively connected to a suction device.

The packaging unit 100 further comprises a folding device 20 intended to abut the blank 7 and configured to cooperate with the mandrel 10 to fold the blank 7 around the mandrel 10, and a guide device to guide the box being formed and to avoid unwanted openings of the panels of the blank with respect to the mandrel.

The guide device comprises a first guide plate 16 and a second guide plate 17 which are placed on opposite sides with respect to the advancement plane of the mandrel and defining a housing 18 for a box to be formed. A first end 17A of the second guide plate 17 positioned further backward with respect to the movement trajectory M is provided with an inclined edge for conveying the blank into the housing 18.

The folding device 20, better visible in FIGS. 3-5, comprises a folding element 21 and a second folding element 22 which are positioned on opposite sides with respect to the advancement plane 200 of the mandrel and are arranged to abut respectively the first panel 7A and the second panel 7B of the blank 7.

The folding element 21 comprises an arm 27 constrained to the frame 9 of the forming carousel 3, and a plurality of prongs 24 spaced apart along a direction transversal to the movement trajectory M and constrained in an adjustable manner to the arm 27. The prongs 24A-24D of the plurality of prongs 24 are intended to abut the blank 7 and to define a first impact surface 21A of the folding element 21 for the abutment of the blank 7 with the folding device 20 at the point of abutment R2. The prongs 24A-24D of the plurality of prongs 24 are positioned so that the first impact surface 21A is oriented along the radial direction of the movement trajectory M at the point of abutment R2 of the blank 7 with the folding element 21.

The prongs 24A-24D are configured so as to define a first impact surface 21A having a profile shaped like an arc of circumference defined by a radius which intersects the advancement plane 200 defined by the mandrel 10.

In the version shown in FIGS. 3 and 4, the prongs 24A-24D of the plurality of prongs 24 are configured so as to define a first impact surface 21A shaped as a conical surface portion. In such a case, the radius of curvature of the prongs 24A-24D of the plurality of prongs 24 decreases from the radially outermost prongs to the radially innermost prongs. In other words, the radius of curvature of the outermost prong 24D is greater than the radius of curvature of the other prongs 24A-24C, while the radius of curvature of the innermost prong 24A is less than the radius of curvature of the other prongs 24B-24D.

Advantageously, the prongs 24A-24D of the plurality of prongs are developed over the same angle of curvature, greater than 20°. In other versions the prongs of the plurality of prongs are developed over angles of curvature different from one another, each angle of curvature being greater than 20°.

The folding element 21 is configured so that the first impact surface 21A is oriented along the radial direction of the movement trajectory M at the point of abutment R2 of the blank 7 with the folding element 21.

The folding member 21 is positioned so that the axis of the cone corresponding to the conical surface is extended parallel to the radial direction and the vertex belongs to the axis of rotation of the mandrel.

In the version shown in FIGS. 5 and 5A the prongs 24A-24D of the plurality of prongs 24 are configured so as to define a first impact surface 21A shaped as a cylindrical surface portion. In such a case, the prongs 24A-24D of the plurality of prongs 24 have the same radius of curvature.

The folding element 21 is positioned so that the first impact surface 21A extends along a direction parallel to the radial direction of said movement trajectory M passing through the point of abutment R2 of the blank 7 with the folding element 21.

In the version shown the folding element 21 comprises four distinct prongs 24A-24D, each pair of prongs being fixed to a respective base 25 which is in turn constrained in an adjustable manner to the arm 27. Each prong 24A-24D is fixed at a first end thereof to the base 25 while their opposed free ends 26 define an upper edge 21B of the folding element 21, i.e. the edge of the folding element 21 furthest from the advancement plane 200.

The four prongs 24A-24D, fixed in pairs to a respective base 25 which is in turn constrained in an adjustable manner to the arm 27. Each prong of the plurality of prongs is fixed at a first end thereof to the base 25 while its opposed free end 26 defines an upper edge 21B of the folding element, i.e. the edge of the folding element furthest away along the vertical axis Z from the advancement plane 200.

The folding element is configured so that the first impact surface 21A is defined by a radius of curvature comprised between about 100 mm and about 1000 mm and developed over an angle greater than 20°. These values of the radius of curvature allow the blank to be gradually folded towards the mandrel, accompanying the blank from the planar configuration to a configuration folded on the mandrel. In addition, the provision of an angle greater than 20° allows to accompany the blank for a considerable stroke, preventing it from folding incorrectly on the mandrel.

Two adjacent prongs 24 of the plurality of prongs are positioned so that an opening 23 is defined between them which is intended to at least partially accommodate an upper retaining element 33 of the feed device 30 when interposed between the mandrel 10 and the folding device 20, as better clarified below.

The folding element 21 is provided with an adjustment device for adjusting the position of at least one prong 24 of the plurality of prongs with respect to the frame 9.

The adjustment device comprises a second adjustment element, not shown in the Figures, for adjusting the position of the base 25 with respect to the arm 27 along a direction transversal to the movement trajectory M. In this way, it is possible to displace the prongs along a direction transversal to the movement trajectory M parallel to the advancement plane 200, as indicated by the arrow F4A as indicated in FIG. 4, in order to modify the position of the openings 23 along a direction transversal to the movement trajectory M. In this way, the zone of the blank 7 on which the blank abuts the prongs 24 is also varied. It is possible to space apart the prongs 24 along a direction transversal to the movement trajectory M for example in order to effectively abut blanks of considerable width, or to approach the prongs in case of blanks with small dimensions. It is also possible to move the prongs along the vertical direction Z, as indicated by the arrow F4 in FIG. 4, in order to displace the position of the first impact surface 21A with respect to the advancement plane 200 and to adapt the folding process to blanks of dimensions different from one another. By displacing the prongs 24 along the vertical direction Z it is also possible to facilitate the interaction between the folding element 21 and the feed device 30, avoiding for example interferences with the upper retaining elements 33 and in particular with the hooking portions 33A thereof.

The adjustment device comprises a third adjustment element, not shown in the Figures, for moving the arm 27 along a direction parallel to the movement trajectory M, as indicated by the arrow F3 in FIGS. 4 and 5A. In this way, it is possible to displace the prongs 24 along a direction parallel to the movement trajectory M by modifying the position of the point of abutment R2 on the movement trajectory M.

The adjustment device comprises a first adjustment element, not shown in the Figures, for oscillating the base 25 with respect to the arm 27, or the arm 27 with respect to the frame 9, or the prongs 24 with respect to the base 25, as indicated by the arrow F1 in FIGS. 3, 5 and 5A in order to vary the inclination of the prongs 24 with respect to the advancement plane 200 and therefore to adjust the folding of the blank 7 with the folding element 21. By varying the inclination of the prongs 24 with respect to the advancement plane 200, the inclination of the first impact surface 21A is varied, effectively modifying the shape of the first impact surface 21A. Therefore, the folding of the blank 7 on the mandrel is adjusted. It is possible, for example, to increase the inclination of the prongs 24 with respect to the advancement plane 200 in order to reduce the space required to fold the blank, or to reduce the inclination of the prongs 24 with respect to the advancement plane 200 in order to perform a more gradual and gentle folding of the blank on the mandrel by increasing the space required to fold the blank.

In an alternative version shown in FIG. 5A the prongs of the plurality of prongs are constrained in an adjustable manner to the base 25 so that they can be oriented with respect to the base 25. In this case, as better clarified below, an adjustment member is provided and configured to displace the prongs 24 along a direction transversal to the movement trajectory M, and/or parallel to the movement trajectory M, and/or to vary the inclination of the prongs with respect to the base 25, as explained above.

With reference to FIG. 5A an alternative version of a folding device according to the invention is shown which differs from that discussed above in that the prongs 24A-24D of the plurality of prongs 24 are constrained in an adjustable manner to the base 25. The parts of this device will be indicated with the same numerical references used for the version described so far.

In such version the adjustment device comprises a second adjustment, not shown in the Figures, for displacing at least one prong 24A-24D of the plurality of prongs 24 along a direction parallel to the movement trajectory M, as indicated by the arrow F3 in FIG. 5A. In this way, it is possible to displace one or more prongs 24 along a direction parallel to the movement trajectory M by modifying the position of the point of abutment R2 on the movement trajectory M.

The adjustment device may comprise an adjustment member, not shown in the Figures, for moving the prongs 24 along a direction transversal to the movement trajectory M, as shown by the arrow F4 and F4A in FIG. 5A. In this way, it is possible to displace the prongs 24 along a direction transversal to the movement trajectory M, parallel to the advancement plane of the mandrel (F4A) or transversally to the advancement plane of the mandrel (F4).

The adjustment device comprises a third adjustment member for oscillating the prongs 24A-24D of the plurality of prongs 24 in both directions of the arrow F1 with respect to the advancement plane 200 of the mandrel 10. By varying the inclination of the prongs 24 with respect to the advancement plane 200, the inclination of the first impact surface 21A is varied, effectively modifying the shape of the first impact surface 21A. Therefore, the folding of the blank 7 on the mandrel is adjusted. It is possible, for example, to increase the inclination of one or more prongs 24 with respect to the advancement plane 200 in order to reduce the space required to fold the blank, or to reduce the inclination of the prongs 24 with respect to the advancement plane 200 in order to perform a more gradual and gentle folding of the blank on the mandrel by increasing the space required to fold the blank.

The adjustment device comprises an adjustment element, not shown in the Figures, for oscillating the prongs with respect to the frame 9 in order to vary the inclination of the prongs 24 with respect to the advancement plane 200 and therefore to adjust the folding of the blank 7 with the folding element 21. By varying the inclination of the prongs 24 with respect to the advancement plane 200, the inclination of the first impact surface 21A is varied, effectively modifying the shape of the first impact surface 21A. Therefore, the folding of the blank 7 on the mandrel is adjusted. It is possible, for example, to increase the inclination of the prongs 24 with respect to the advancement plane 200 in order to reduce the space required to fold the blank, or to reduce the inclination of the prongs 24 with respect to the advancement plane 200 in order to perform a more gradual and gentle folding of the blank on the mandrel by increasing the space required to fold the blank.

The prongs may be oscillatable with respect to the base 25, like in the version shown in FIG. 5A, and/or the base 25 may be oscillatable with respect to the arm 27 like in the version of FIGS. 3-5, and/or the arm 27 may be oscillatable with respect to the frame 9.

The second folding element 22 comprises an impact surface 22A shaped to interact with the blank 7 and convey it towards the mandrel 10. In the version shown the impact surface 22A comprises a first portion 22B having an almost vertical position and at least one accompanying portion 22C that is inclined with respect to the vertical Z with an inclination angle of about 30°.

The first impact surface 21A, and the impact surface 22A are made of low friction coefficient material, usually plastic or metallic material. The first impact surface 21A, and the impact surface 22A are made of low friction coefficient material, usually plastic or metallic material, to favour the sliding of the blank and avoid jamming.

The packaging unit 100 further comprises a retaining device 60 displaceable along an actuation trajectory, between an operating position E1, in which the retaining device 60 is approached to the first abutment surface 10A of the mandrel to retain the blank 7 against the first abutment surface 10A and a non-operating position E2 in which the retaining device 60 is spaced apart from the first abutment surface 10A.

The retaining device 60 is positioned so as to be interposed, in the operating position E1, between the folding element 21 and the second folding element 22 to retain the intermediate panel 7C of the blank 7.

The retaining device comprises a lamina intended to retain the intermediate panel 7C of the blank 7 and configured to be positioned in an advanced position with respect to the mandrel along the movement trajectory M.

The packaging unit 100 further comprises an actuation member, not shown in the Figures, intended to move the retaining device 60 between the operating position E1 and the non-operating position E2. In the operating position E1 of the retaining device 60 the blank 7 is retained against the first abutment surface 10A of the mandrel 10 while in the non-operating position E2 of the retaining device 60 it is moved away from the blank 7.

The retaining device 60 is operatively associated with the mandrel 10 so as to be carried, via the movement device, together with the mandrel 10, along the movement trajectory M. The retaining device 60 is also movable with respect to the mandrel 10 in order to be displaced between the operating position E1 and the non-operating position E2.

The operation of the packaging unit 100 is now explained. An article 1 is deposited on a mandrel 10 at the receiving zone 202 and moved together with the mandrel 10 along the movement trajectory M. The mandrel 10 is moved along the movement trajectory M at a movement speed VM.

The feed device 30 feeds a blank 7 towards the movement carousel 3, positioning it in a feeding position A1 provided along the movement trajectory M in an advanced position with respect to the mandrel 10 and moves the blank 7 for a feeding stroke of the movement trajectory M.

The mandrel 10 in displacing along the trajectory M approaches the blank 7 until, in the first abutment position R1, the first abutment surface 10A of the mandrel 10 abuts the blank 7. Subsequently, the mandrel 10 moves along the feeding stroke together with the blank 7 and the feed device 30 up to a retaining position R4 in which the retaining device 60 is positioned in the operating position E1 and engages the intermediate panel 7C of the blank 7 to retain it on the mandrel 10.

From the retaining position R4 the mandrel 10 continues to transport the blank 7 along the movement trajectory M up to a release position R3 in which the feed device 30 releases the blank 7. From the release position R3 the mandrel 10 transports the blank 7 up to the abutment position R2 where the folding device 20 abuts the blank 7. The presence of the retaining device 60 allows the blank 7 to be released from the feed device 30 upstream of the abutment position R2.

The presence of the openings 23 allows, also in this case, to simplify the movement of the feed device 30 avoiding that interferences are generated among the components of the packaging unit or that the feed device 30 must be immediately displaced from the movement trajectory M.

The presence of the openings 23 allows to provide the release position R3 immediately upstream of the abutment position R2. The feed device 30 can accompany the blank 7 along the movement trajectory M and release it just before the abutment position R2, since the appendages 35 of the upper retaining elements 33 can be passed through the openings 23 provided between the prongs 24, while the hooking portion 33A passes above the upper edge 21A of the folding element 21 and the lower retaining element 34 passes between the second folding element 22 and the advancement plane 200 of the mandrel 10.

The configuration of the folding device makes it possible to avoid necessarily having to suddenly move the feed device 30 away from the movement trajectory M to avoid interferences among the various components.

In one version the abutment position R2 is provided downstream of the release position R3, i.e. the blank 7 is abutted by the folding device 20 after being released by the feed device 30. In this case the blank is retained on the mandrel by the retaining device 60.

The presence of the openings 23 allows, also in this case, to simplify the movement of the feed device 30 avoiding that interferences are generated among the components of the packaging unit or that the feed device 30 must be immediately displaced from the movement trajectory M.

As mentioned above, the possibility of adjusting the position of the prongs with respect to the advancement plane allows to adjust the folding of the blank based on the characteristics of the blank. For example, it is possible to fold more gradually a blank having large dimensions and/or made of a more fragile material in order to optimise the folding of the blank avoiding tears and allowing to obtain a box with regular shape. It is also possible to fold faster a blank with small dimensions, or made of resistant material that breaks less easily. It is also possible to avoid interferences between the folding element and the upper retaining elements.

In the abutment position R2, the blank 7 abuts the first impact surface 21A of the folding element 21. By moving the mandrel 10 along the movement trajectory M the blank is progressively folded by the folding element towards the mandrel and is guided by the prongs 24A-24D progressively towards the mandrel 10.

The presence of the openings 23 allows to provide the release position R3 immediately upstream of the abutment position R2. The feed device 30 can accompany the blank 7 along the movement trajectory M and release it just before the abutment position R2, since the appendages 35 of the upper retaining elements 33 can be passed through the openings 23 provided between the prongs 24, while the hooking portion 33A passes above the upper edge 21A of the folding element 21 and the lower retaining element 34 passes between the second folding element 22 and the advancement plane 200 of the mandrel 10.

The configuration of the folding device makes it possible to avoid necessarily having to suddenly move the feed device 30 away from the movement trajectory M to avoid interferences among the various components.

In an alternative version the abutment position R2 in which the folding device 20 abuts the blank 7 is provided between the first impact position R1 and the release position R3. The presence of the openings 23 allows to provide the release position R3 downstream of the abutment position R2. The feed device 30 can accompany the blank 7 after the abutment position R2 along the movement trajectory M, since the appendages 35 of the upper retaining elements 33 can be passed through the openings 23 provided between the prongs 24, while the hooking portion 33A passes above the prongs 24 and the lower retaining element 34 passes between the second folding element 22 and the advancement plane 200 of the mandrel 10.

From the abutment position R2, the first panel 7A of the blank 7 is folded progressively towards the mandrel 10 by the prongs of the folding element 21 and the second panel 7B by the second folding element 22. The surface of the folding element 21 guides the first panel 7A towards the mandrel. Subsequently, the mandrel 10 continues its movement along the movement trajectory M coming out of the folding device 20 to enter the housing 18 defined between the first guide plate 16 and the second guide plate 17.

Following the movement of the mandrel 10 from the abutment position R2, the first panel 7A of the blank 7 is folded progressively through the prongs 24 and the second panel 7B through the second folding element 22 and then through the first end 17A of the second guide plate 17. The prongs 24 of the folding element 21 guide the first panel 7A towards the mandrel 10. Subsequently, the mandrel 10 continues its movement along the movement trajectory entering the housing 18 defined between the first guide plate 16 and the second guide plate 17.

As mentioned above, the possibility of adjusting the position of the prongs with respect to the advancement plane allows to adjust the folding of the blank based on the characteristics of the blank. For example, it is possible to fold more gradually a blank having large dimensions and/or made of a more fragile material in order to optimise the folding of the blank avoiding tears and allowing to obtain a box with regular shape. It is also possible to fold faster a blank with small dimensions, or made of resistant material that breaks less easily. It is also possible to avoid interferences between the folding element and the upper retaining elements.

These advantages are obtained without complicating the structure of the packaging unit. After adjusting the position of the folding element, the folding device is kept fixed during the folding process.

The prongs 24 of the plurality of prongs are intended to abut the blank 7 and to define a first impact surface 21A of the folding element 21 for the abutment of the blank 7 with the folding device 20 at the point of abutment R2, shown in FIG. 4.

The folding element is configured so that the first impact surface 21A is defined by a radius of curvature comprised between about 100 mm and about 1000 mm and developed over an angle greater than 20°. The values of the radius of curvature allow the blank to be gradually folded towards the mandrel, accompanying the blank from the planar configuration to a configuration folded on the mandrel. In addition, providing an angle greater than 20° allows to accompany the blank for a considerable stroke, preventing it from folding incorrectly on the mandrel.

1. Packaging unit for packaging (100; 200; 300) articles (1) in boxes (2), comprising:
a support frame (9);
a mandrel (10) configured to accommodate one of said articles (1) inside it;
a movement device (50) configured to move said mandrel (10) with respect to said frame (9) along a movement trajectory (M) of the mandrel (10);
a feed device (30) configured to feed a blank (7) towards said mandrel (10) along a feeding trajectory which intersects said movement trajectory (M);
a folding device (20) mounted on said frame (9) at said movement trajectory (M) and configured to cooperate with said mandrel (10) to fold said blank (7) around said mandrel (10) and to form one of said boxes (2),
wherein said folding device (20) comprises a folding element (21) configured to abut said blank (7) when said blank (7) is positioned between said mandrel (10) and said folding element (21), and an adjustment device for modifying the position of said folding element (21) with respect to said frame (9) so as to adjust the folding of said blank (7) around said mandrel (10).

2. Packaging unit according to the preceding claim, wherein said adjustment device comprises a first adjustment element for modifying the inclination of said folding element (21) with respect to said movement trajectory (M).

3. Packaging unit according to any one of the preceding claims, wherein said adjustment device comprises a second adjustment element for displacing said folding element (21) along at least one direction transversal to said movement trajectory (M).

4. Packaging unit according to any one of the preceding claims, wherein said adjustment device comprises a third adjustment element for displacing said folding element (21) along a direction parallel to said movement trajectory (M).

5. Packaging unit according to any one of the preceding claims, wherein said folding element (21) defines a first impact surface (21A), for the abutment of said blank (7) with said folding device (20).

6. Packaging unit according to the preceding claim wherein said first impact surface (21A) has an arched shape, preferably convex towards said blank (7).

7. Packaging unit according to the preceding claim wherein said first impact surface (21A) has a profile shaped like an arc of circumference.

8. Packaging unit according to the preceding claim wherein said profile is an arc of a circumference defined by a radius comprised between about 50 mm and about 1000 mm, preferably between about 100 mm and about 500 mm.

9. Packaging unit according to one of the preceding claims and further comprising a second folding element (22) arranged on the opposite side with respect to an advancement plane (200) of said mandrel (10), so that said folding element (21) and said second folding element (22) are arranged to respectively abut a first portion (7A) and a second portion (7B) of said blank (7) that are provided on opposite sides of said blank (7) with respect to an advancement plane (200) defined by said mandrel (10) when moved along said movement trajectory (M).

10. Packaging unit according to one of the preceding claims wherein said folding element (21) is provided with at least one opening (23) intended to at least partially house said feed device (30) when interposed between said mandrel (10) and said folding device (20).

11. Packaging unit according to the preceding claim, wherein said folding element (21) comprises a plurality of prongs (24) intended to abut the blank (7), wherein two adjacent prongs (24) of said plurality of prongs (24) are separated by said at least one opening (23).

12. Packaging unit according to the preceding claim wherein said plurality of prongs (24) is constrained in an adjustable manner to a base (25) of said folding element (21).

13. Packaging unit according to claim 12, wherein a position of at least one prong (24) of said plurality of prongs (24) is adjustable with respect to a position of at least another prong (24) of said plurality of prongs (24).

14. Method for packaging articles (1) in a box (2) comprising:
depositing at least one of said articles in a mandrel (10),
moving said mandrel (10) along a movement trajectory (M),
displacing a blank by means of a feed device (30) and positioning said blank (7) along said movement trajectory (M) of said mandrel (10) in an advanced position with respect to said mandrel (10),
abutting said blank (7) with a first abutment surface (10A) of said mandrel,
providing at said movement trajectory (M) a folding device (20) mounted on a frame (9) and configured to cooperate with said mandrel (10) to fold said blank (7) around said mandrel (10) when said blank (7) is positioned between said mandrel (10) and said folding device (20),
further abutting said blank (7) with a folding element (21) of said folding device (20) on the opposite side with respect to said mandrel (10) to fold said blank (7) around said mandrel (10),
modifying the position of said folding element (21) with respect to said frame (9) so as to adjust the folding of said blank (7) around said mandrel (10).

15. Packaging method according to claim 14 wherein said modifying comprises varying an inclination of said folding element (21) with respect to said movement trajectory (M).

16. Packaging method according to any one of claims 14 to 15 wherein said modifying comprises displacing said folding element (21) along a direction transversal to said movement trajectory (M).

17. Packaging method according to any one of claims 14 to 16 wherein said modifying comprises displacing said folding element (21) along a direction parallel to said movement trajectory (M).

18. Packaging method according to any one of claims 14 to 17 wherein it is further provided to abut a first portion (7A) and a second portion (7B) of said blank (7) that are provided on opposite sides of said blank (7) with respect to an advancement plane (200) defined by said mandrel (10) when moved along said movement trajectory (M) respectively with said folding element (21) and a second folding element (22).

19. Method according to the preceding claim and further comprising modifying the position of said second folding element (22) with respect to said movement trajectory (M).

20. Packaging method according to any one of claims 14 to 19 wherein said folding element (21) comprises a plurality of prongs (24) intended to abut the blank (7) and said modifying comprises displacing at least one prong (24) of said plurality of prongs (24) with respect to a position of at least another prong (24) of said plurality of prongs (24).

21. Method according to the preceding claim wherein said modifying comprises displacing at least one prong (24) of said plurality of prongs (24) so as to define a first impact surface (21A) of said folding element (21) having a cylindrical shape, convex towards said blank.

22. Method according to claim 20 wherein said modifying comprises displacing at least one prong of said plurality of prongs (24) so as to define a first impact surface (21A) of said folding element (21) having a conical shape with an axis extended along a radial direction of said movement trajectory (M) and a vertex substantially coincident with a centre of rotation of said movement trajectory (M).

23. Method for carrying out a format change in the packaging of articles (1) in a box (2) comprising:
a. depositing at least one of said articles (1) in a first mandrel (10),
b. moving said first mandrel (10) along a movement trajectory (M),
c. displacing a first blank by means of a feed device (30) and positioning said first blank (7) along said movement trajectory (M) of said first mandrel (10) in an advanced position with respect to said first mandrel (10),
d. providing at said movement trajectory (M) a folding device (20) mounted on a frame (9) and configured to cooperate with said first mandrel (10) to fold said first blank (7) around said first mandrel (10) when said first blank (7) is positioned between said first mandrel (10) and said folding device (20),
e. abutting said first blank (7) with a first abutment surface (10A) of said first mandrel,
f. further abutting said first blank (7) with a folding element (21) of said folding device (20) on the opposite side with respect to said first mandrel (10) to fold said first blank (7) around said first mandrel (10), so as to form a first box (2) containing one of said articles (1),
g. replacing said first mandrel (10) with a second mandrel having dimensions different from said first mandrel and/or replacing said first blank (7) with a second blank having dimensions different from said first blank (7), so as to change the format of said boxes (2),
h. modifying the position of said folding element (21) with respect to said frame (9) as a function of the dimensions of said second blank and/or of said second mandrel,
i. repeating steps a.-f. with said second blank in place of said first blank (7) and said second mandrel in place of said first mandrel (10) so as to form a second box, different from said first box, containing one of said articles.
